(19) United States
(12) Patent Application Publication
(10) Pub. No.: US 2025/0351081 A1
(43) Pub. Date: Nov. 13, 2025

(54) BLUETOOTH LE PERIPHERAL CONNECTION POWER OPTIMIZATION

(71) Applicant: Silicon Laboratories Inc., Austin, TX (US)

(72) Inventors: Lauri Hintsala, Vihti (FI); Wesam Koraim, Espoo (FI)

(21) Appl. No.: 18/662,242

(22) Filed: May 13, 2024

(51) Int. Cl. H04W 52/02; H04L 5/00

(52) U.S. Cl. CPC H04W 52/0235; H04L 5/0053; H04W 52/0261

(57) ABSTRACT

A system and method of reducing the power consumption of a connected Bluetooth LE peripheral device is disclosed. Rather than responding to every packet transmitted from the central device, the peripheral device judiciously responds, sending a response in those situations where a response is required by the central device. In this way, the peripheral device is able to conserve battery life by not responding to most of the empty packets that are transmitted by the central device. The peripheral device also includes mechanisms to ensure that the connection is not terminated by the central device due to a lack of response from the peripheral device.

### FIELD

This disclosure describes a system and method to reduce the power consumption of a connected Bluetooth LE peripheral device.

### BACKGROUND

The Bluetooth protocol is one of many wireless network protocols that are currently in use. The Bluetooth protocol is commonly used to connect smartphones to watches, headphones, speakers, and other accessories. Bluetooth Low Energy utilizes 40 physical channels in the 2.4 GHZ ISM band, each channel separated by 2 MHZ.

One concept in the Bluetooth protocol is a connection. A connection is formed between a central device and a peripheral device. Once established, communications between the two devices occur in a well defined manner. Specifically, the central device referred to as connInterval, to the provides a parameter, peripheral device, which is the connection interval. This connection interval is a multiple of 1.25 milliseconds in the range from 7.5 milliseconds to 4 seconds. The start of each connection interval may be referred to as the connection anchor point. At each connection anchor point, the central device transmits a packet to the peripheral device. This packet may contain data, or may simply be a 0-byte data payload packet, also referred to an empty packet, which is transmitted to preserve synchronicity between the central device and the peripheral device. The peripheral device then responds to this packet. That response may be an acknowledgment, or may be a packet that contains data. The packets that are transmitted during a connection interval are referred to as a connection event. In some embodiments, there may be multiple packets per connection event.

Thus, in most systems, the peripheral device is transmitting at least one packet during each connection interval. This may result in greater power consumption than desired and may result in shortened battery life.

Therefore, it would be beneficial if there was a system and method that allowed the connected peripheral device to be more judicious about when it responds to the central device. In this way, the battery life of the peripheral device may be extended without affecting the operation of the Bluetooth connection.

### SUMMARY

A system and method of reducing the power consumption of a connected Bluetooth LE peripheral device is disclosed. Rather than responding to every packet transmitted from the central device, the peripheral device judiciously responds, sending a response in those situations where a response is required by the central device. In this way, the peripheral device is able to conserve battery life by not responding to most of the empty packets that are transmitted by the central device. The peripheral device also includes mechanisms to ensure that the connection is not terminated by the central device due to a lack of response from the peripheral device.

According to one embodiment, a method of reducing power consumption of a Bluetooth peripheral device that is connected to a Bluetooth central device is disclosed. The method comprises receiving, from the Bluetooth central device, a packet; checking, at the Bluetooth peripheral device, whether the packet has a non-zero data byte count; checking, at the Bluetooth peripheral device, wherein the packet has a More Data (MD) bit set; and transmitting, from the Bluetooth peripheral device, an acknowledgment to the Bluetooth central device in response to the packet only if the packet has a non-zero byte count or the MD bit set. In some embodiments, the method further comprises checking, at the Bluetooth peripheral device, whether there is data to transmit in a transmission queue; and transmitting a peripheral data packet to the Bluetooth central device in response to the packet if there is data to transmit in the transmission queue. In some embodiments, the Bluetooth peripheral device enters sleep mode after transmission of the acknowledgment. In some embodiments, the Bluetooth peripheral device enters sleep mode after receipt of the packet if the packet has a zero byte count and the MD bit is not set.

According to another embodiment, a method of reducing power consumption of a Bluetooth peripheral device that is connected to a Bluetooth central device is disclosed. The method comprises monitoring an amount of time or a number of connection intervals, at the Bluetooth peripheral device, since the Bluetooth peripheral device last transmitted a packet that was successfully received by the Bluetooth central device; receiving, from the Bluetooth central device, a packet; checking, at the Bluetooth peripheral device, whether the packet has a non-zero data byte count; checking, at the Bluetooth peripheral device, wherein the packet has a More Data (MD) bit set; and transmitting, from the Bluetooth peripheral device, an acknowledgment to the Bluetooth central device in response to the packet only if: the packet has a non-zero byte count; the packet has the MD bit set; or a connection to the Bluetooth central device is close to timing out. In some embodiments, the method further comprises checking, at the Bluetooth peripheral device, whether there is data to transmit in a transmission queue; and transmitting a peripheral data packet to the Bluetooth central device in response to the packet if there is data to transmit in the transmission queue. In some embodiments, the Bluetooth peripheral device uses a counter to count a number of consecutive connection intervals that have passed since the Bluetooth peripheral device last transmitted a packet that was successfully received by the Bluetooth central device. In certain embodiments, the Bluetooth peripheral device determines a number of connection intervals (N) that are disposed within a connection timeout period. In certain embodiments, the Bluetooth peripheral device transmits the acknowledgment if the number of consecutive connection intervals that have passed during which the Bluetooth peripheral device did not transmit a packet that was successfully received by the Bluetooth central device is greater than N−2. In certain embodiments, the Bluetooth peripheral device transmits the acknowledgment if the number of consecutive connection intervals that have passed during which the Bluetooth peripheral device did not transmit a packet that was successfully received by the Bluetooth central device is greater than N−X, wherein X is between 2 and N−1. In some embodiments, the Bluetooth peripheral device uses a timer to time an amount of time that has passed since the Bluetooth peripheral device last transmitted a packet that was successfully received by the Bluetooth central device. In certain embodiments, the Bluetooth peripheral device transmits the acknowledgment if a value of the timer is greater than 90% of a connection timeout period.

According to another embodiment, a Bluetooth device is disclosed. The Bluetooth device comprises a Bluetooth network interface; a processing unit; and a memory device, containing instructions, which when executed by the processing unit, enable the Bluetooth peripheral device to: receive a packet from a Bluetooth central device to which the Bluetooth peripheral device has a connection; and transmit an acknowledgment in response to the packet only if: the packet has a non-zero byte count; the packet has the MD bit set; or a connection to the Bluetooth central device is close to timing out. In some embodiments, the Bluetooth peripheral device comprises a counter to count a number of consecutive connection intervals that have passed since the Bluetooth peripheral device last transmitted a packet that was successfully received by the Bluetooth central device. In certain embodiments, the Bluetooth peripheral device determines a number of connection intervals (N) that are disposed within a connection timeout period. In certain embodiments, the Bluetooth peripheral device transmits the acknowledgment if the number of consecutive connection intervals that have passed during which the Bluetooth peripheral device did not transmit a packet to the Bluetooth central device is greater than N−2. In certain embodiments, the Bluetooth peripheral device transmits the acknowledgment if the number of consecutive connection intervals that have passed during which the Bluetooth peripheral device did not transmit a packet to the Bluetooth central device is greater than N−X, wherein X is between 2 and N−1. In some embodiments, the Bluetooth peripheral device comprises a timer to time an amount of time that has passed since the Bluetooth peripheral device last transmitted a packet that was successfully received by the Bluetooth central device. In some embodiments, the Bluetooth peripheral device transmits the acknowledgment if a value of the timer is greater than 90% of a connection timeout period. In certain embodiments, the memory device further comprising instructions, which when executed by the processing unit, enable the Bluetooth peripheral device to: check whether there is data to transmit in a transmission queue; and transmit a peripheral data packet to the Bluetooth central device if there is data to transmit in the transmission queue.

### BRIEF DESCRIPTION OF THE DRAWINGS

For a better understanding of the present disclosure, reference is made to the accompanying drawings, in which like elements are referenced with like numerals, and in which:

FIG. 1A shows a block diagram of a Bluetooth device according to one embodiment;

FIG. 1B shows a Bluetooth network including a central device and a peripheral device;

FIGS. 2A-2D show four different scenarios for communications between the central device and the peripheral device;

FIG. 3 shows an optimization of the scenario shown in FIG. 2A;

FIG. 4 shows an optimization of the scenario shown in FIG. 2B;

FIG. 5 shows an optimization of the scenario shown in FIG. 2C;

FIG. 6 shows an optimization of the scenario shown in FIG. 2D; and

FIG. 7 shows the operation of the peripheral device according to one embodiment.

### DETAILED DESCRIPTION

This disclosure describes a system and method by which a connected Bluetooth LE device, acting as a peripheral device, may conserve battery life by selectively responding to packets transmitted by the central device.

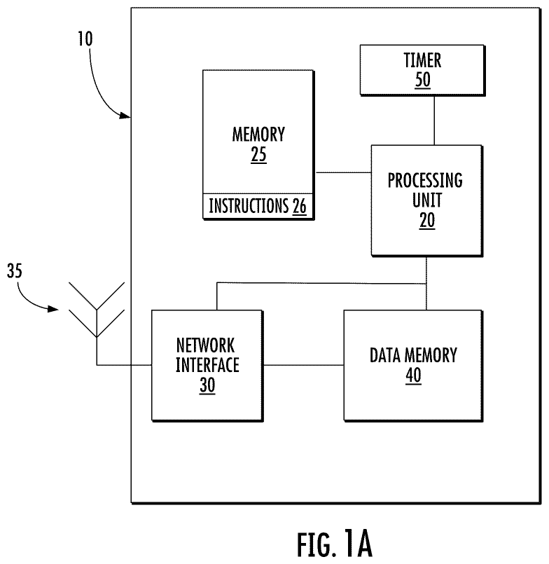

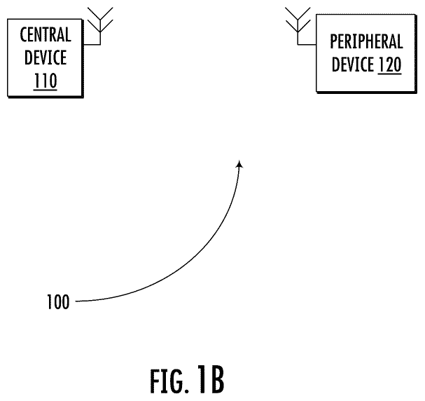

FIG. 1A shows a block diagram of a representative Bluetooth device 10 that may be used to implement the disclosed method of conserving battery life.

The Bluetooth device 10 has a processing unit 20 and an associated memory device 25. The processing unit 20 may be any suitable component, such as a microprocessor, embedded processor, an application specific circuit, a programmable circuit, a microcontroller, or another similar device. This memory device 25 contains the instructions 26, which, when executed by the processing unit 20, enable the Bluetooth device 10 to perform the functions described herein. This memory device 25 may be a non-volatile memory, such as a FLASH ROM, an electrically erasable ROM or other suitable devices. In other embodiments, the memory device 25 may be a volatile memory, such as a RAM or DRAM.

While a memory device 25 is disclosed, any non-transitory computer readable medium may be employed to store these instructions. For example, read only memory (ROM), a random access memory (RAM), a magnetic storage device, such as a hard disk drive, or an optical storage device, such as a CD or DVD, may be employed. Furthermore, these instructions may be downloaded into the memory device 25, such as for example, over a network connection (not shown), via CD ROM, or by another mechanism. These instructions may be written in any programming language, which is not limited by this disclosure. Thus, in some embodiments, there may be multiple computer readable non-transitory media that contain the instructions described herein. The first computer readable non-transitory media may be in communication with the processing unit 20, as shown in FIG. 1A. The second computer readable non-transitory media may be a CDROM, or a different memory device, which is located remote from the Bluetooth device 10. The instructions contained on this second computer readable non-transitory media may be downloaded onto the memory device 25 to allow execution of the instructions by the Bluetooth device 10.

The Bluetooth device 10 also includes a Bluetooth network interface 30 that connects with a Bluetooth network 100 (see FIG. 1B) using an antenna 35.

The Bluetooth device 10 may include a data memory device 40 in which data that is received and transmitted by the Bluetooth network interface 30 is stored. This data memory device 40 is traditionally a volatile memory. The processing unit 20 has the ability to read and write the data memory device 40 so as to communicate with the other devices in the Bluetooth network 100. In some embodiments, the data memory device 40 contains a receive queue for packets that are received by the Bluetooth network interface 30 and a transmission queue for packets that are to be transmitted by the Bluetooth network interface 30.

The Bluetooth device 10 may also include a timer 50. The timer 50 may be a free running timer, which is incremented at a predetermined rate. In some embodiments, the timer 50 may be used to wake the Bluetooth device 10 from sleep mode.

Although not shown, the Bluetooth device 10 also has a power supply, which may be a battery.

While the processing unit 20, the memory device 25, the Bluetooth network interface 30, the timer 50 and the data memory device 40 are shown in FIG. 1A as separate components, it is understood that some or all of these components may be integrated into a single electronic component. Rather, FIG. 1A is used to illustrate the functionality of the Bluetooth device 10, not its physical configuration.

FIG. 1B shows a Bluetooth network 100 that includes a first Bluetooth device, referred to as the central device 110 and a second Bluetooth device, referred to as the peripheral device 120. The peripheral device 120 may have an architecture similar to that shown in FIG. 1A. The architecture of the central device 110 may be similar to that shown in FIG. 1A, but may include a more powerful processing unit, more memory and other network interfaces.

The central device 110 may use one of several mechanisms to establish a connection. For legacy advertising, the central device 110 transmits a CONNECT_IND_PDU on the primary advertising channel. For legacy advertising, the peripheral device 120 does not respond. For extended advertising, the central device 110 may transmit an AUX_CONNECT_REQ PDU on the secondary advertising channel to the peripheral device 120. The peripheral device 120 may respond with an AUX_CONNECT_RSP PDU on the secondary advertising channel. For periodic advertising with responses (PAwR), the central device 110 may transmit an AUX_CONNECT_REQ PDU on the periodic advertising channel to the peripheral device 120. The peripheral device 120 may respond with an AUX CONNECT RSP PDU on the periodic advertising channel. Packets can then be transmitted between the central device 110 and the peripheral device 120. These devices are deemed to be in a connected state. As part of the establishment of the connection, the central device 110 may provide a parameter, known as connInterval, or connection interval, to the peripheral device 120. This parameter informs the peripheral device 120 when packets are to be transmitted by the central device 110. This connection interval is a multiple of 1.25 milliseconds in the range from 7.5 milliseconds to 4 seconds. Another parameter that is provided is referred to the connection supervisor timeout. This parameter establishes the amount of time that may pass without a response from the peripheral device 120 before the central device 110 terminates the connection. The start of each connection interval may be referred to as the connection anchor point. At each connection anchor point, the central device 110 transmits a packet to the peripheral device. The peripheral device 120 may then respond to this packet. In some embodiments, there may be multiple packets transmitted during a connection interval. This allows the peripheral device 120 to enter a sleep mode for extended periods of time between connection anchor points.

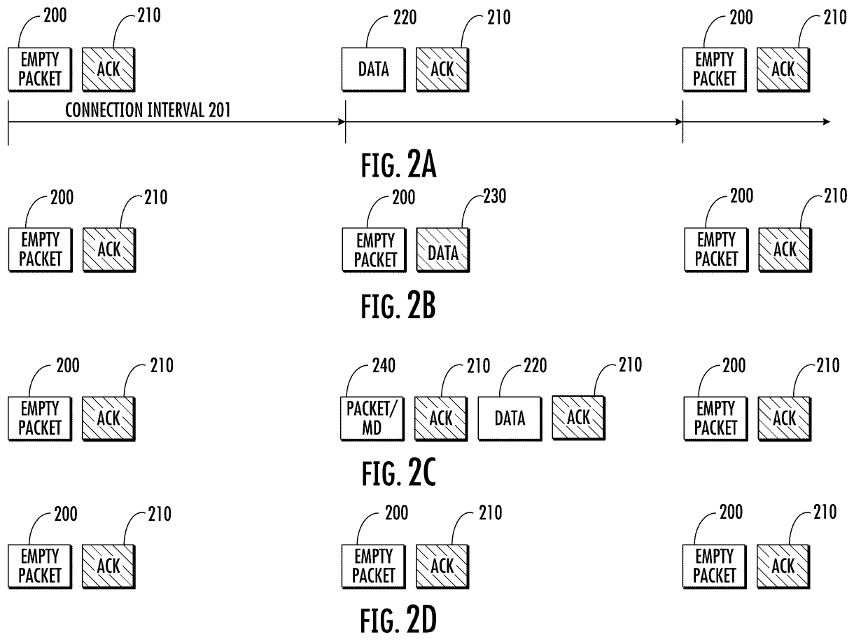

FIGS. 2A-2D show several different typical scenarios where packets are transmitted between a central device 110 and a peripheral device 120 according to the prior art. Each scenario shows three connection intervals 201. However, it is understood that this is simply a snapshot in time, as the connection lasts longer than three connection intervals. In each of the following drawings, packets sent by the peripheral device 120 are shown in cross-hatch.

In each of these scenarios, the central device 110 begins by transmitting a data packet to the peripheral device. These data packets are formatted as Data Physical Channel Data PDUs. These PDUs include a header and optionally a payload. The header includes information such as the length of the payload, a sequence number and the more data (MD) bit. In this disclosure, a Data Physical Channel Data PDU with a 0-byte data payload will be referred to as an empty packet. In FIG. 2A, the central device 110 begins by transmitting an empty packet 200 to the peripheral device 120. Later, during a subsequent connection interval 201, the central device 110 transmits a data packet 220 to the peripheral device 120. After transmitting the data packet 220, the central device 110 may transmit another empty packet 200 during the next connection interval 201. Note that the peripheral device 120 transmits an acknowledgment 210 in response to each packet transmitted by the central device 110. Acknowledgments are normal connection packets and the ACK information is contained in the header using one bit. A change in the sequence number is interpreted as an ACK, while an unchanged sequence number is interpreted as a NACK.

In FIG. 2B, the central device 110 has no data to transmit to the peripheral device 120, and therefore sends an empty packet 200 at the start of each connection interval 201. However, during the second connection interval, the peripheral device 120 has data to share with the central device 110. Therefore, rather than transmitting an acknowledgment 210 (which is done during the first and third connection intervals), the peripheral device 120 transmits a peripheral data packet 230 to the central device 110.

FIG. 2C is similar to FIG. 2A, except that the data that the central device 110 transmits to the peripheral device 120 cannot be contained within a single data packet. Thus, the central device 110 transmits a data packet 240 with the more data (MD) bit set. By setting the MD bit, the peripheral device 120 is informed that one or more additional data packets 220 will be transmitted as well. If there are N total data packets to be sent, the MD bit will be set in the first (N−1) packets, while the last packet will be a data packet 220 without the MD bit set. As noted above, the peripheral device 120 transmits an acknowledgment 210 in response to each packet transmitted by the central device 110.

Finally, FIG. 2D shows a scenario where there is an extended period of time during which the central device 110 has no data to transmit to the peripheral device 120. In this scenario, the central device transmits an empty packet 200 during each connection interval 201. As described above, the peripheral device 120 transmits an acknowledgment 210 in response to each packet transmitted by the central device 110.

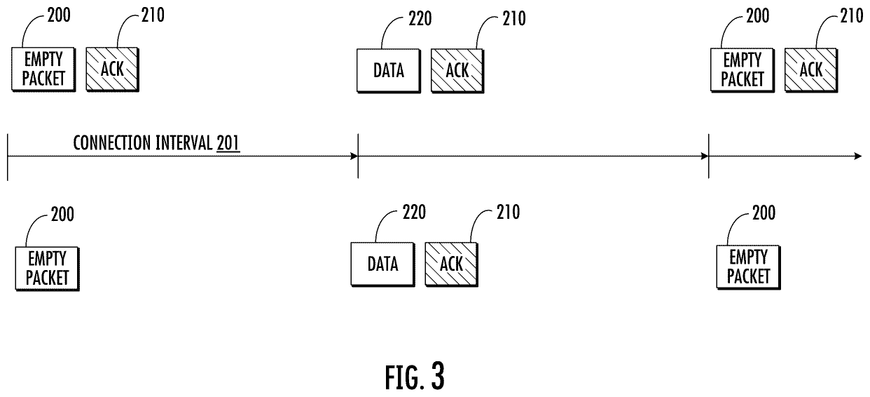

FIGS. 3-6 shows how each of the scenarios shown in FIGS. 2A-2D may be modified to reduce the power consumption of the peripheral device 120.

The top of FIG. 3 shows the scenario illustrated in FIG. 2A. The bottom shows the optimization that may be made to reduce the power consumption of the peripheral device 120 without causing unwanted retransmissions and connection terminations. In this embodiment, the peripheral device 120 does not respond to an empty packet 200 transmitted by the central device 110. Thus, during the first and third connection intervals 201, the peripheral device 120 does not transmit a packet and returns to sleep mode after receipt of the empty packet 200. However, when the central device 110 transmits a data packet 220, the peripheral device 120 responds with an acknowledgment 210, to inform the central device 110 that the data packet 220 was received. Thus, the peripheral device will respond to any data packets 220 (i.e. packets with non-0 data payloads) transmitted by the central device 110. The peripheral device 120 returns to sleep mode after transmission of the acknowledgment 210.

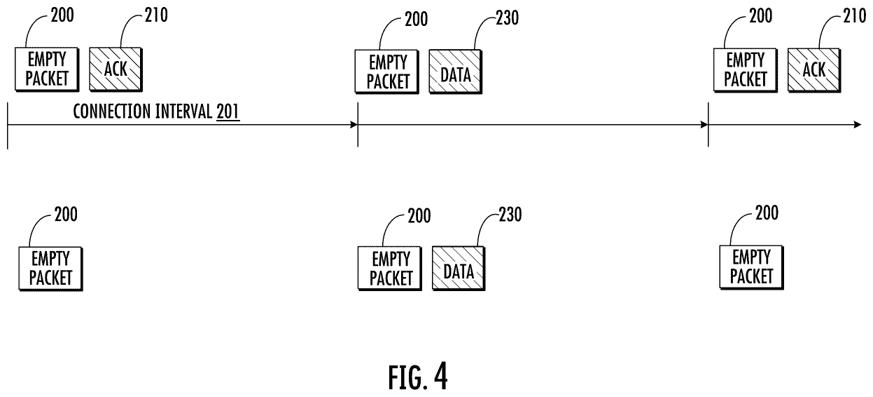

The top of FIG. 4 shows the scenario illustrated in FIG. 2B. The bottom shows the optimization that may be made to reduce the power consumption of the peripheral device 120 without causing unwanted retransmissions and connection terminations. As was shown in FIG. 3, the peripheral device 120 does not respond to an empty packet 200 transmitted by the central device 110. Thus, during the first and third connection intervals 201, the peripheral device 120 does not transmit a packet and returns to sleep mode after receipt of the empty packet 200. However, when the peripheral device 120 has data to transmit to the central device 110, it responds to one of the empty packets 200 with a peripheral data packet 230. Thus, the peripheral device 120 will transmit a peripheral data packet 230 in response to a packet (either an empty packet 200 or a data packet 220) from the central device 110 when it has data in its transmission queue. The peripheral device 120 returns to sleep mode after transmission of the peripheral data packet 230.

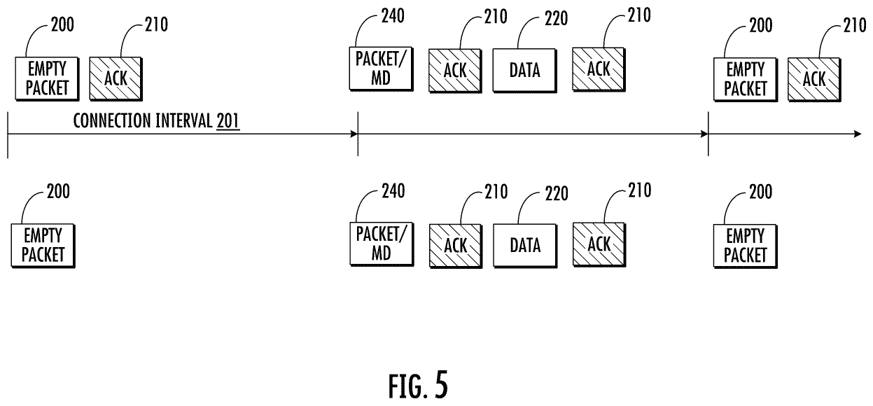

The top of FIG. 5 shows the scenario illustrated in FIG. 2C. The bottom shows the optimization that may be made to reduce the power consumption of the peripheral device 120 without causing unwanted retransmissions and connection terminations. In this embodiment, the peripheral device 120 does not respond to an empty packet 200 transmitted by the central device 110. Thus, during the first and third connection intervals 201, the peripheral device 120 does not transmit a packet and returns to sleep mode after receipt of the empty packet 200. However, when the central device 110 transmits a data packet 240 with the more data (MD) bit set, the peripheral device 120 responds with an acknowledgment 210, to inform the central device 110 that the data packet 220 was received. Further, the peripheral device 120 also transmits acknowledgments 210 for each data packet 220 that follows the data packet 240 with the MD bit set. Thus, the peripheral device will respond to any packets 240 that have the MD bit set and any data packets 220 transmitted by the central device 110. The peripheral device 120 then returns to sleep mode after transmission of the acknowledgment 210.

Thus, FIGS. 3-5 show that the peripheral device 120 does not respond to empty packets 200, unless there is data in its transmission queue to transmit to the central device 110. Further, FIGS. 3-5 show that the peripheral device 120 responds to data packets 220 that contain data and also responds to any packet with the MD bit set.

In summary, the peripheral device 120 is configured to only respond to the central device 110 if:
the central device 110 transmits a data packet with a non-0-byte data payload count;
the central device 110 transmits a packet with the more data (MD) bit set; or
the peripheral device 120 has data to transmit to the central device.

Stated differently, the peripheral device 120 only transmits an acknowledgment if the received packet has a non-zero data byte count or a MD bit set. The peripheral device 120 does not transmit an acknowledgment if there is a zero data byte count and the MD bit is not set. In addition, the peripheral device responds with a peripheral data packet 230 if it has data to transmit. In all cases, the peripheral device 120 returns to sleep mode afterwards.

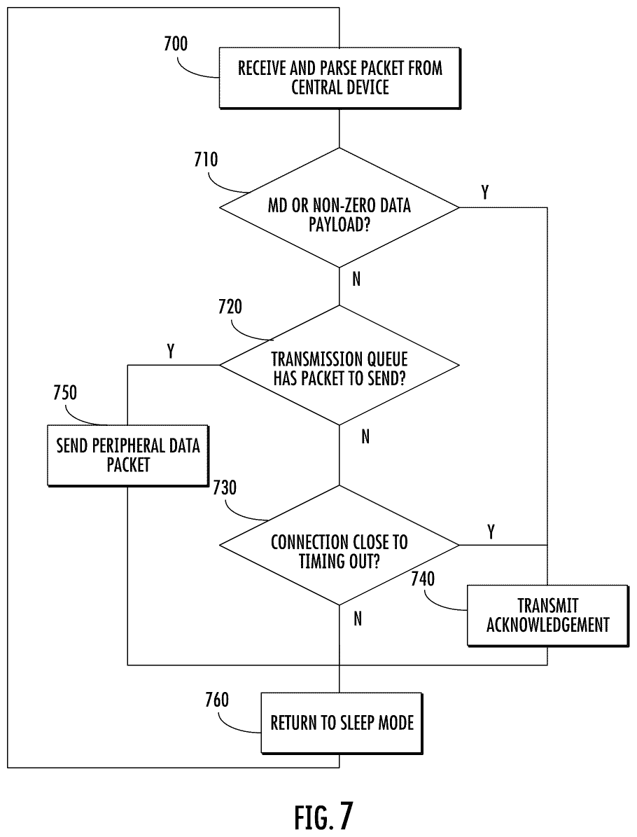

FIG. 7 shows the operation of the peripheral device 120. First, as shown in Box 700, the peripheral device 120 receives and parses the packet that is received from the central device 110. As shown in Decision Box 710, the peripheral device 120 checks for a non-0-byte data payload or a MD bit set. Upon detection of either of these conditions, the acknowledgment 210 is transmitted, as shown in Box 740. Further, as shown in Decision Box 720, the peripheral device 120 has knowledge of its transmission queue. If it has a packet to transmit to the central device 110, the peripheral device 120 transmits a peripheral data packet 230, as shown in Box 750. In some embodiments, if neither of these conditions is met, the peripheral device returns to sleep mode (see Box 760) until the next connection interval. Note that the sequence described above may vary. For example, the peripheral device 120 may check its transmission queue before checking the size of the data payload and the MD bit of the received packet.

This concept may be further enhanced by ensuring that the lack of acknowledgments does not cause the connection to be terminated. For example, if the central device 110 has no data to send to the peripheral device 120 for an extended period of time, it is possible that the peripheral device 120 may not transmit any packets to the central device 110 for a period of time that exceeds the negotiated connection timeout period. The negotiated connection timeout period may be several seconds in some embodiments. This may cause unwanted overhead to re-establish the connection.

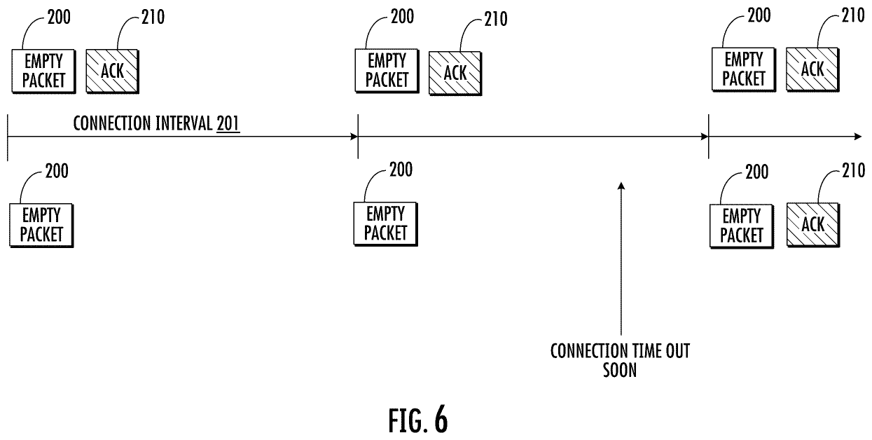

Thus, the peripheral device 120 may monitor this situation to ensure a connection timeout does not occur. This scenario is shown in FIG. 6. The top of FIG. 6 shows the scenario shown in FIG. 2D. The bottom shows the optimization that may be made to reduce the power consumption of the peripheral device 120 without causing unwanted retransmissions and connection terminations. In this embodiment, as described above, the peripheral device 120 does not typically respond to an empty packet 200 transmitted by the central device 110. However, the peripheral device 120 may maintain a counter (or timer) that records the number of connection intervals or the amount of time since the last transmission from the peripheral device 120. If the peripheral device 120 determines that a connection timeout may occur soon, it will transmit an acknowledgment 210 to the next packet received from the central device 110, regardless of packet type. This functionality is also shown in Decision Box 730 of FIG. 7.

Thus, the peripheral device 120 utilizes an indicator that informs it that the time period during which the peripheral device 120 has not transmitted any packets is approaching the connection timeout period. When this indication is present, the peripheral device 120 transmits an acknowledgment during the next connection interval, regardless of the type of packet transmitted by the central device 110. This indicator can be implemented in a number of ways. In each embodiment, the peripheral device 120 may set the indicator to a value that allows it to transmit multiple acknowledgments 210 before the expiration of the connection timeout period. By using such a value, the peripheral device 120 may be able to transmit acknowledgments during a plurality of connection intervals 201 before the connection timeout occurs. This may allow for the possibility of lost acknowledgment packets while still maintaining the connection. For example, the peripheral device 120 may transmit acknowledgments during 2 or more successive connection intervals once the indication is present. After transmitting the one or more acknowledgments, the peripheral device 120 may return to its default mode of operation.

As noted above, this indicator may be implemented in a number of ways. In one embodiment, the peripheral device 120 may be aware of the connection timeout period and the connection interval. By dividing the latter into the former, the peripheral device 120 may determine how many connection intervals occur before a connection timeout. Thus, in some embodiments, the peripheral device 120 may use this number of connection intervals to modify its behavior. For example, the peripheral device 120 may calculate that there are N connection intervals before a connection times out. The peripheral device 120 may use a counter that is incremented each connection interval 201. Further, each time the peripheral device 120 determines that the central device 110 successfully received a packet that the peripheral device 120 transmitted, this counter is reset. Determination of a successfully received packet may be detected by the peripheral device 120 by observing a modification of the sequence number in the next packet transmitted by the central device 110. Thus the value of the counter is indicative of the number of consecutive connection intervals during which the peripheral device 120 did not transmit a packet to the central device 110. When that value of the counter approaches N, the peripheral device 120 may transmit an acknowledgment 210 during the next connection interval, regardless of the type of packet transmitted by the central device 110. In some embodiments, the peripheral device 120 may transmit the acknowledgment 210 when the counter reaches a value that is greater than N−X, where X is between 2 and N−1. In one embodiment, X may be 2. In other embodiments, the peripheral device 120 may transmit the acknowledgment 210 when the counter reaches a value that is greater than N−5 or N−10 (X=5 or 10, respectively). Note that the peripheral device 120 may continue transmitting acknowledgments during each subsequent connection interval 201 until the peripheral device 120 determines that the central device 110 received an acknowledgment. At this point, the counter is reset and the peripheral device 120 stops transmitting the acknowledgments. In some embodiments, the peripheral device 120 may dynamically adjust when the acknowledgment 210 is first transmitted. For example, this may be based on link quality. A small value of X may be used in a low noise environment, while a larger value is used when there is a significant amount of interference.

In another embodiment, the peripheral device 120 may use a timer to determine when to transmit this acknowledgment 210. For example, the peripheral device 120 may set the timer to expire when it reaches a value that is close to the connection timeout period. For example, the timer may be set to a value that is equal to the connection timeout period−M*connection interval 201, wherein M is a value between 2 and N−1, such as 10 or less. In another embodiment, the timer may be set to a value that is equal to a percentage of the connection timeout period, such as 90%. This timer is reset whenever the peripheral device 120 determines that the central device 110 successfully received a packet that the peripheral device 120 transmitted. If the timer reaches its maximum value (if counting upward) or reaches zero (if counting downward), the peripheral device 120 transmits an acknowledgment 210 during the next connection interval 201. It may continue transmitting an acknowledgment during each subsequent connection interval 201 until it determines that the central device 110 received its acknowledgment.

Thus, in certain embodiments, the peripheral device 120 also responds to the central device 110 if the connection is close to timing out.

The present system and method have many advantages. This approach offers many benefits. In one test, it was found that, during one 7.5 millisecond connection interval, the power consumption of the peripheral device 120 may be reduced by up to 80% when an acknowledgment 210 is not transmitted, as compared to traditional operation. Further, this approach also serves to minimize latency. For example, another way to reduce power consumption is to increase the connection interval. This approach increases latency as data cannot be transmitted until the next connection interval. Bluetooth also supports a concept known as peripheral latency which allows the peripheral device 120 to sleep through multiple connection intervals. However, like longer connection intervals, this approach increases latency. Finally, by reducing the number of acknowledgments that are transmitted, less interference is created for neighboring devices.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A method of reducing power consumption of a Bluetooth peripheral device that is connected to a Bluetooth central device, the method comprising:
receiving, from the Bluetooth central device, a packet;
checking, at the Bluetooth peripheral device, whether the packet has a non-zero data byte count;
checking, at the Bluetooth peripheral device, wherein the packet has a More Data (MD) bit set; and
transmitting, from the Bluetooth peripheral device, an acknowledgment to the Bluetooth central device in response to the packet only if the packet has a non-zero byte count or the MD bit set.

2. The method of claim 1, further comprising:
checking, at the Bluetooth peripheral device, whether there is data to transmit in a transmission queue; and
transmitting a peripheral data packet to the Bluetooth central device in response to the packet if there is data to transmit in the transmission queue.

3. The method of claim 1, wherein the Bluetooth peripheral device enters sleep mode after transmission of the acknowledgment.

4. The method of claim 1, wherein the Bluetooth peripheral device enters sleep mode after receipt of the packet if the packet has a zero byte count and the MD bit is not set.

5. A method of reducing power consumption of a Bluetooth peripheral device that is connected to a Bluetooth central device, the method comprising:
monitoring an amount of time or a number of connection intervals, at the Bluetooth peripheral device, since the Bluetooth peripheral device last transmitted a packet that was successfully received by the Bluetooth central device;
receiving, from the Bluetooth central device, a packet;
checking, at the Bluetooth peripheral device, whether the packet has a non-zero data byte count;
checking, at the Bluetooth peripheral device, wherein the packet has a More Data (MD) bit set; and
transmitting, from the Bluetooth peripheral device, an acknowledgment to the Bluetooth central device in response to the packet only if:
the packet has a non-zero byte count;
the packet has the MD bit set; or
a connection to the Bluetooth central device is close to timing out.

6. The method of claim 5, further comprising:
checking, at the Bluetooth peripheral device, whether there is data to transmit in a transmission queue; and
transmitting a peripheral data packet to the Bluetooth central device in response to the packet if there is data to transmit in the transmission queue.

7. The method of claim 5, wherein the Bluetooth peripheral device uses a counter to count a number of consecutive connection intervals that have passed since the Bluetooth peripheral device last transmitted a packet that was successfully received by the Bluetooth central device.

8. The method of claim 7, wherein the Bluetooth peripheral device determines a number of connection intervals (N) that are disposed within a connection timeout period.

9. The method of claim 8, wherein the Bluetooth peripheral device transmits the acknowledgment if the number of consecutive connection intervals that have passed during which the Bluetooth peripheral device did not transmit a packet that was successfully received by the Bluetooth central device is greater than N−2.

10. The method of claim 8, wherein the Bluetooth peripheral device transmits the acknowledgment if the number of consecutive connection intervals that have passed during which the Bluetooth peripheral device did not transmit a packet that was successfully received by the Bluetooth central device is greater than N−X, wherein X is between 2 and N−1.

11. The method of claim 5, wherein the Bluetooth peripheral device uses a timer to time an amount of time that has passed since the Bluetooth peripheral device last transmitted a packet that was successfully received by the Bluetooth central device.

12. The method of claim 11, wherein the Bluetooth peripheral device transmits the acknowledgment if a value of the timer is greater than 90% of a connection timeout period.

13. A Bluetooth peripheral device, comprising:
a Bluetooth network interface;
a processing unit; and
a memory device, containing instructions, which when executed by the processing unit, enable the Bluetooth peripheral device to:
receive a packet from a Bluetooth central device to which the Bluetooth peripheral device has a connection; and
transmit an acknowledgment in response to the packet only if:
the packet has a non-zero byte count;
the packet has the MD bit set; or
a connection to the Bluetooth central device is close to timing out.

14. The Bluetooth peripheral device of claim 13, further comprising a counter to count a number of consecutive connection intervals that have passed since the Bluetooth peripheral device last transmitted a packet that was successfully received by the Bluetooth central device.

15. The Bluetooth peripheral device of claim 14, wherein the Bluetooth peripheral device determines a number of connection intervals (N) that are disposed within a connection timeout period.

16. The Bluetooth peripheral device of claim 15, wherein the Bluetooth peripheral device transmits the acknowledgment if the number of consecutive connection intervals that have passed during which the Bluetooth peripheral device did not transmit a packet to the Bluetooth central device is greater than N−2.

17. The Bluetooth peripheral device of claim 16, wherein the Bluetooth peripheral device transmits the acknowledgment if the number of consecutive connection intervals that have passed during which the Bluetooth peripheral device did not transmit a packet to the Bluetooth central device is greater than N−X, wherein X is between 2 and N−1.

18. The Bluetooth peripheral device of claim 5, further comprising a timer to time an amount of time that has passed since the Bluetooth peripheral transmitted a packet that was successfully received by the Bluetooth central device.

19. The Bluetooth peripheral device of claim 18, wherein the Bluetooth peripheral device transmits the acknowledgment if a value of the timer is greater than 90% of a connection timeout period.

20. The Bluetooth peripheral device of claim 13, wherein the memory device further comprising instructions, which when executed by the processing unit, enable the Bluetooth peripheral device to:
check whether there is data to transmit in a transmission queue; and
transmit a peripheral data packet to the Bluetooth central device if there is data to transmit in the transmission queue.
